(19) United States
(12) Patent Application Publication
(10) Pub. No.: US 2021/0368584 A1
(43) Pub. Date: Nov. 25, 2021

(54) PASSIVE AND ACTIVE CALIBRATION METHODS FOR A RESISTIVE HEATER

(71) Applicant: Watlow Electric Manufacturing Company, St. Louis, MO (US)

(72) Inventors: Stanton H. BREITLOW, Winona, MN (US); Brittany PHILLIPS, St. Louis, MO (US); Kevin PTASIENSKI, O'Fallon, MO (US)

(73) Assignee: Watlow Electric Manufacturing Company, St. Louis, MO (US)

(21) Appl. No.: 17/324,848

(22) Filed: May 19, 2021

Related U.S. Application Data
(60) Provisional application No. 63/027,285, filed on May 19, 2020.

(51) Int. Cl. H05B 1/02

(52) U.S. Cl. CPC H05B 1/02

(57) ABSTRACT

A method of calibrating a heater includes powering the heater to a first temperature setpoint. The heater includes a resistive heating element that has a varying temperature coefficient of resistance. The method further includes concurrently obtaining a plurality of resistance measurements of the resistive heating element and a plurality of reference temperature measurements of a reference member as the heater cools from a first temperature setpoint to a second temperature setpoint that is lower than the first temperature setpoint, and generating a resistance-temperature calibration table that correlates the plurality of resistance measurements with the plurality of reference temperature measurements.

### CROSS-REFERENCE TO RELATED APPLICATION

This application claims priority to and the benefit of U.S. Provisional Application 63/027,285 filed on May 19, 2020. The disclosure of the above application is incorporated herein by reference.

### FIELD

The present disclosure relates to calibrating a resistive heater.

### BACKGROUND

The statements in this section merely provide background information related to the present disclosure and may not constitute prior art.

Pedestal heaters for semiconductor processing typically include a heating plate that has a substrate and one or more resistive heating elements provided at the substrate to define one or more heating zones. In some applications, the resistive heating elements function as heaters and as temperature sensors with only two leads wires operatively connected to the resistive heating element rather than four (e.g., two for the heating element and two for a discrete temperature sensor). In such resistive heating elements, the resistive material defines a temperature coefficient of resistance (TCR), and the temperature of the resistive heating elements can be determined based on the TCR and measured resistance of the heating element.

A pedestal heater, such as a multizone heater, can be controlled by a control system that determines the temperature of the resistive heating elements based on the resistance of the resistive heating element. To control the multizone heater, the control system calculates resistance based on voltage and/or current measurements and determines the temperature of each zone based on the resistance calculated. While predefined resistance-temperature data such as tables that associate resistance values to temperature may be used, heaters may operate differently from each other even if the resistive heating elements are made of the same material. This can be caused by, for example, manufacturing variations, material batch variations, age of the heater, number of cycles, and/or other factors, which causes inaccuracies in the calculated temperatures. These and other issues related to the use of two-wire resistive heaters, for example in multizone applications, are addressed by the present disclosure.

### SUMMARY

This section provides a general summary of the disclosure and is not a comprehensive disclosure of its full scope or all of its features.

In one form, the present disclosure is directed to a method that includes powering a heater that is in an isothermal environment to a first temperature setpoint, where the heater comprises a resistive heating element having a varying temperature coefficient of resistance. The method further includes concurrently obtaining a plurality of resistance measurements of the resistive heating element and a plurality of reference temperature measurements of a reference member as the heater passively cools from a first temperature setpoint to a second temperature setpoint that is lower than the first temperature setpoint and generating a resistance-temperature calibration table that correlates the plurality of resistance measurements with the plurality of reference temperature measurements.

In another form, the method further includes turning-off power to the heater when the heater is at the first temperature setpoint to passively cool the heater.

In yet another form, the reference member is an exterior surface of the heater.

In one form, the plurality of reference temperature measurements of the surface of the heater are obtained with an infrared camera.

In another form, the plurality of reference temperature measurements are obtained with a thermocouple wafer and the reference member is the thermocouple wafer.

In yet another form, to obtain a resistance measurement from among the plurality of resistance measurements, the method further includes measuring at least one of an electric current and a voltage concurrently with the plurality of reference temperatures, and determining the resistance measurement based on the measured at least one electric current and the voltage.

In one form, the present disclosure is directed to a method that includes powering a heater in a designated environment to a first temperature setpoint, where the heater comprises a resistive heating element having a varying temperature coefficient of resistance. The method further includes concurrently obtaining a plurality of resistance measurements of the resistive heating element and a plurality of reference temperature measurements of a reference member as the heater passively cools from a first temperature setpoint to a second temperature setpoint that is lower than the first temperature setpoint and generating a resistance-temperature calibration table that correlates the plurality of resistance measurements with the plurality of reference temperature measurements.

In another form, the designated environment for the heater is an isothermal environment.

In yet another form, the designated environment is a standard operating environment at which the heater is operable to heat a workpiece.

In one form, the method further includes turning-off power to the heater when the heater is at the first temperature setpoint to passively cool the heater.

In another form, the reference member is an exterior surface of the heater.

In yet another form, the plurality of reference temperature measurements of the exterior surface of the heater are obtained with an infrared camera.

In one form, the plurality of reference temperature measurements are obtained with a thermocouple wafer and the reference member is the thermocouple wafer.

In another form, to obtain a resistance measurement from among the plurality of resistance measurements, the method further includes measuring at least one of an electric current and a voltage concurrently with the plurality of reference temperatures, and determining the resistance measurement based on the measured at least one electric current and the voltage.

In still another form, the present disclosure is directed to a control system for controlling a heater having a resistive heating element. The control system includes a power converter configured to provide an output voltage that is adjustable to the heater and a controller configured to determine the output voltage to be applied to the heater. The controller includes a memory configured to store a plurality of control programs for controlling the heater, wherein the plurality of control programs includes a calibration process. The controller further includes a processor configured to execute the plurality of control programs, wherein with the heater is in a designated environment. The calibration process includes instructions to turn-on power to the heater to heat the heater to a first temperature setpoint, concurrently obtain a plurality of resistance measurements of the resistive heating element and a plurality of reference temperature measurements of a reference member as the heater passively cools from the first temperature setpoint to a second temperature setpoint, and generate a resistance-temperature calibration table that correlates the plurality of resistance measurements with the plurality of reference temperature measurements.

In one form, the calibration process further includes instructions to turn-off power to the heater when the heater is at the first temperature setpoint to passively cool the heater.

In another form, the reference member is an exterior surface of the heater.

In still another form, the second temperature setpoint is lower than the first temperature setpoint.

In yet another form, the designated environment is an isothermal environment.

In another form, to obtain a resistance measurement from among the plurality of resistance measurements, the calibration process further includes instructions to measure at least one of an electric current and a voltage concurrently with the plurality of reference temperature measurements, and determine the resistance measurement based on the at least one electric current and the voltage.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1A is a functional block diagram of a thermal system in accordance with the present disclosure;

FIG. 1B is functional block diagram of a control system of the thermal system of FIG. 1A;

FIG. 2A is a top view of an exemplary heater having resistive heating elements;

FIG. 2B is a representative partial cross-sectional view of the heater of FIG. 2A;

FIG. 3 is a graph illustrating a resistance temperature offset for a two-zone pedestal heater in accordance with the present disclosure;

FIG. 4 illustrates a passive calibration setup in accordance with the present disclosure;

FIGS. 5A and 5B illustrate an active calibration test setup in accordance with the present disclosure; and

FIG. 6 is a flowchart of a resistance-temperature calibration process in accordance with the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure is generally directed toward a resistance-temperature (R-T) calibration process for a heater, which may be a multizone heater, having resistive heating elements that are operable as heaters and sensors. The R-T calibration process described herein generates R-T offset data that correlates a plurality of resistance measurements with a plurality of reference temperature measurements. The R-T offset data is then used during standard operation of the multizone heater to determine a temperature of the resistive heating element(s) based on a measured resistance of the resistive heating element(s).

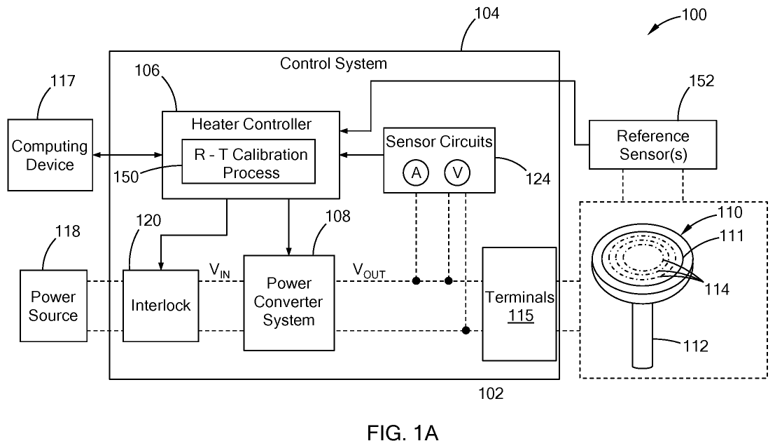

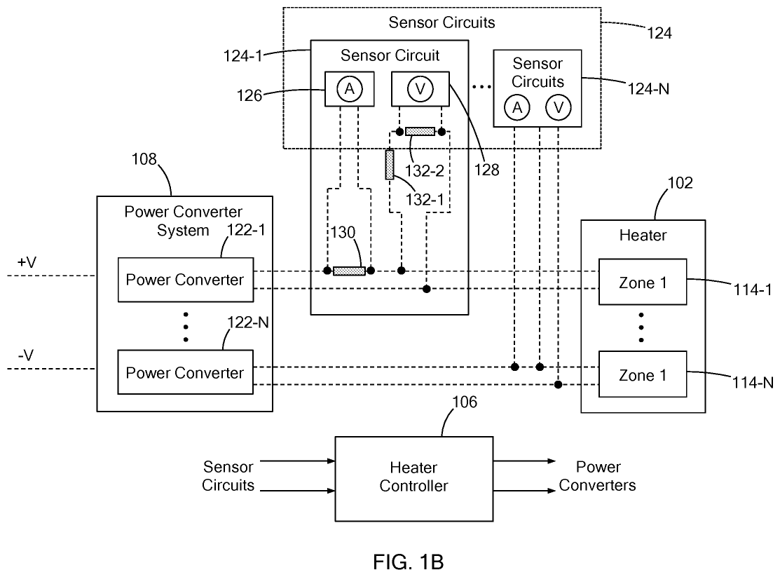

To demonstrate the R-T calibration process according to the teachings of the present disclosure, an example configuration of a thermal system having a multizone heater and a control system is first provided. Referring to FIGS. 1A and 1B, a thermal system 100 includes a multizone pedestal heater 102 and a control system 104 having a heater controller 106 and a power converter system 108. In one form, the heater 102 includes a heating plate 110 and a support shaft 112 disposed at a bottom surface of the heating plate 110. The heating plate 110 includes a substrate 111 and a plurality of resistive heating elements (not shown) embedded in or disposed along a surface of the substrate 111. For example, one such heater is described in co-pending application U.S. Ser. No. 16/196,699, filed Nov. 20, 2018 and titled “MULTI-ZONE PEDESTAL HEATER HAVING A ROUTING LAYER”, which is commonly owned with the present application and the contents of which are incorporated herein by reference in its entirety.

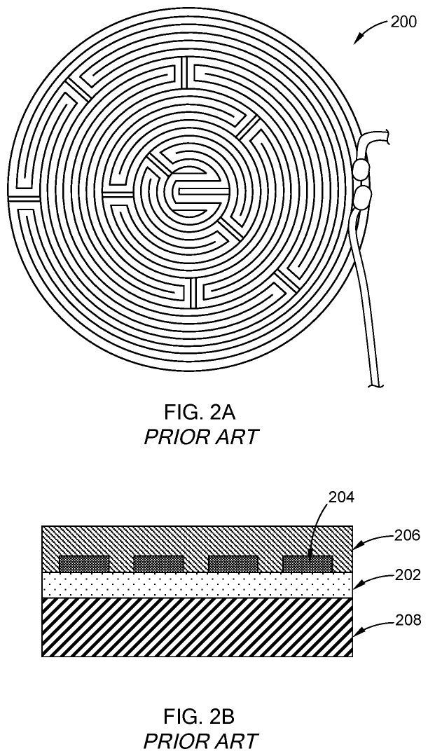

In one form, the substrate 111 may be made of ceramic or aluminum. The resistive heating elements are independently controlled by the heater controller 106 and define a plurality of heating zones 114 as illustrated by the dashed-dotted lines in FIG. 1A. It is readily understood that the heating zones could take a different configuration and include two or more heating zones while remaining within the scope of the present disclosure. For example, referring to FIGS. 2A and 2B, the heater 102 may be a heater 200 that includes a dielectric layer 202, a resistive layer 204 defining one or more resistive heating traces (i.e., resistive heating elements), and a protective layer 206 disposed on a substrate 208.

In one form, the heater 102 is a “two-wire” heater in which the resistive heating elements function as heaters and as temperature sensors with only two leads wires operatively connected to the heating element rather than four. Such two-wire capability is disclosed in, for example, U.S. Pat. No. 7,196,295, which is commonly assigned with the present application and incorporated herein by reference in its entirety. Typically, in a two-wire system, the resistive heating elements are defined by a material that exhibits a varying resistance with varying temperature such that an average temperature of the resistive heating element is determined based on a change in resistance of the resistive heating element. In one form, the resistance of the resistive heating element is calculated by first measuring the voltage across and the current through the heating elements and then, using Ohm's law, the resistance is determined. The resistive heating element may be defined by a relatively high temperature coefficient of resistance (TCR) material, a negative TCR material, or in other words, a material having a non-linear TCR. While the heater 102 is provided as a pedestal heater, the present disclosure may be applicable to other types of heaters, such as an electrostatic chuck (ESC) heater, a nozzle heater, or a fluid heater, among others, and should not be limited to pedestal heaters as illustrated and described herein.

The control system 104 controls the operation of the heater 102, and more particularly, is configured to independently control power to each of the zones 114. In one form, the control system 104 is electrically coupled to the zones 114 via terminals 115, such that each zone 114 is coupled to two terminals providing power and sensing temperature.

In one form, the control system 104 is communicably coupled (e.g., wireless and/or wired communication) to a computing device 117 having one or more user interfaces such as a display, a keyboard, a mouse, a speaker, a touch screen, among others. Using the computing device 117, a user may provide inputs or commands such as temperature setpoints, power setpoints, commands to execute a test or a process stored by the control system.

The control system 104 is electrically coupled to a power source 118 that supplies an input voltage (e.g., 240V, 208V) to the power converter system 108 by way of an optional interlock 120. The interlock 120 controls power flowing between the power source 118 and the power converter system 108 and is operable by the heater controller 106 as a safety mechanism to shut-off power from the power source 118. While illustrated in FIG. 1A, the control system 104 may not include the interlock 120.

The power converter system 108 is operable to adjust the input voltage and apply an output voltage (V_{OUT}) to the heater 102. In one form, the power converter system 108 includes a plurality of power converters 122 (122-1 to 122-N in figures) that are operable to apply an adjustable power to the resistive heating elements of a given zone 114 (114-1 to 114-N in figures). One example of such a power converter system is described in U.S. Pat. No. 10,690,705, which is commonly assigned with the present application and incorporated herein by reference in its entirety. In this example, each power converter includes a buck converter that is operable by the heater controller to generate a desired output voltage that is less than or equal to the input voltage for one or more heating elements of a given zone 114. Accordingly, the power converter system is operable to provide a customizable amount of power (i.e., a desired power) to each zone of the heater.

With the use of a two-wire heater, the control system 104 includes sensor circuits 124 (i.e., 124-1 to 124-N in FIG. 1B) to measure electrical characteristics of the resistive heating elements (i.e., voltage and/or current), which is then used to determine performance characteristics of the zones, such as resistance, temperature, and other suitable information. In one form, a given sensor circuit 124 includes an ammeter 126 and a voltmeter 128 to measure a current flowing through and a voltage applied to the heating element(s) in a given zone 114, respectively. Each ammeter 126 includes a shunt 130 for measuring the current, and each voltmeter 128 includes a voltage divider 132, which is represented by resistors 132-1 and 132-2. Alternatively, the ammeter 126 may measure current using a HAL sensor or a current transformer in lieu of the shunt 130. In one form, the ammeter 126 and the voltmeter 128 are provided as a power metering chip to simultaneously measure current and voltage regardless of the power being applied to the heating element. In another form, the voltage and/or current measurements may be taken at zero-crossing, as described in U.S. Pat. No. 7,196,295.

The heater controller 106 includes one or more microprocessors and memory for storing computer readable instructions executed by the microprocessors. The heater controller 106 is configured to perform one or more control processes in which the heater controller 106 determines the desired power to be applied to the zones, such as 100% of input voltage, 90% of input voltage, etc. Example control processes are described U.S. Pat. No. 10,690,705 and also U.S. Pat. No. 10,908,195, which is commonly assigned with the present application and incorporated herein by reference in its entirety. In one form, a control process adjusts the power applied to the resistive heating elements based on a temperature of the resistive heating elements and/or of the workpiece.

To obtain an accurate temperature measurement, the heater controller 106 is operable to perform a R-T calibration process 150 of the present disclosure to generate a correlation between the resistance of the resistive heating element with a temperature of a reference area about the heater 102 (i.e., a reference temperature). More particularly, during normal operations in which the heater 102 is heating a workpiece, the heater controller 106 determines the surface temperature of the heater 102 upon which the workpiece is positioned based on a current resistance measurement and the R-T offset data. Thus, eliminating the use of a separate discrete sensor.

Referring again to FIG. 1A, for the R-T calibration process, the thermal system 100 is equipped with one or more discrete reference sensors 152 to measure a temperature of the reference area. The reference sensor 152 may be an infrared camera, a thermocouple (TC) wafer, one or more thermocouples, a resistance temperature detector, and/or other suitable sensor for measuring temperature. For example, in one form, the reference sensor 152 is an infrared camera that is arranged above the heater 102 to measure the surface temperature of the heater 102 with the surface of the heater 102 being the reference area and the surface temperature being the reference temperature. In another example, the reference sensor may be a TC wafer having a wafer and a plurality of TCs distributed along the wafer for measuring temperature. During calibration, the TC wafer is positioned on the heater 102 and is secured to the surface using various methods including but not limited to pressurizing a chamber having the heater 102 and TC wafer, bonding the TC wafer to the heater 102, or by gravity. Each TC of the TC wafer measures a temperature which is provided to the control system 104. With the surface of the TC wafer in contact with the heater 102, the reference area is provided as the surface of the heater 102 and the reference temperature is the temperature along the surface of the heater.

For the R-T calibration process, the control system 104, is configured to heat the heater 102, or more particularly, heat the surface of the heater 102 to a first temperature setpoint (T_sp1). Once the surface has a uniform temperature profile, the control system 104 turns off power to the heater and concurrently measures the reference temperature and the resistance of the resistive heating elements for each zone until the reference temperature is equal to a second temperature setpoint (T_sp2) that is less than the first temperature setpoint. For the resistance measurements, the control system 104 acquires the voltage and current measurements from the sensor circuits and determines the resistance of the resistive heating elements. In one form, the reference temperature measurements and the resistance measurements are measured continuously based on a processing rate of the reference sensor and the sensor circuit. In another form, the reference temperature measurements and the resistance measurements are periodically measured (e.g., every 5 mins, 10 mins, among other time intervals). It should be readily understood that any number of measurements may be taken for determining the temperature offset data and should not be limited to the examples described herein.

The control system 104 then correlates the reference temperature measurements with the resistance measurements of the resistive heating elements to obtain R-T offset data. Based on the type and/or number of reference sensors, the control system 104 processes the raw measurements from the reference sensor to obtain the reference temperature measurements. For example, for an IR camera, the thermal image provided by the IR camera provides the surface temperature throughout the surface of the heater which is heated by multiple heating zones define by one or more resistive heating elements. Accordingly, for a given heating element, the control system 104 associates a resistance of the given resistive heating element with a reference temperature measurement for a respective area heated by the given resistive heating element. A similar correlation may be completed for a TC wafer such that temperatures measurements from TCs provided in a particular area of the wafer are associated with the resistive heating element heating that area.

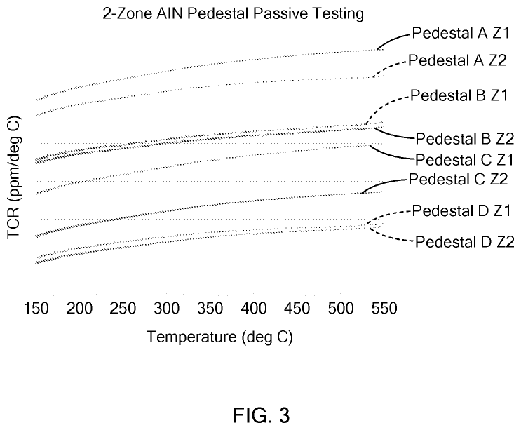

The control system 104 generates and stores the R-T offset data and uses the R-T offset data to determine the reference temperature based on a measured resistance of the resistive heating element. In one form, the R-T offset data may be provided as a table, a chart, and/or an algorithm, among other formats. R-T offset data can be provided as just resistance and temperature measurement or it can be a parameter dependent on resistance and/or temperature, such as TCR vs temperature. For example, FIG. 3 illustrates a graph that captures R-T offset for a two-zone pedestal heater. Specifically, the graph provides data (TCR vs. temperature) for pedestals A to D, each having a zone 1 (Z1) and a zone 2 (Z2).

The R-T calibration process of the present disclosure may be performed under different conditions to acquire material properties of the resistive heating elements and correlate the material properties to, for example, the surface temperature of the heater or other reference areas. In particular, the R-T calibration process may be performed as a passive calibration with the heater being thermally isolated, or in an isothermal environment, and/or as an active calibration with the heater provided in its operating environment such as a semiconductor processing chamber.

In lieu of or in addition to a standard R-T curve for a specific material defining the resistive heating elements, the passive calibration generates a custom R-T curve for the resistive heating elements within the heater. To obtain the custom R-T curve, the heater 102 is thermally isolated to minimize heat loss from the resistive heating elements such that the surface temperature of the heater is equal to or substantially the same as that of the resistive heating elements.

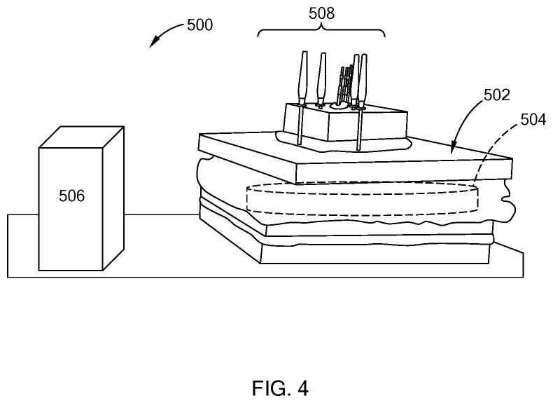

In an example configuration, FIG. 4 illustrates a passive calibration setup 500 in which a multizone heater is provided in an isothermal environment. Specifically, the passive calibration 500 includes an isothermal chamber 502 that houses a multizone heater 504 having a plurality of resistive heating elements. The multizone heater 504 is similar to the heater 102. Here, the isothermal chamber 502 includes insulating material that encases the heater 504 to thermally isolate the heater and thus, reduces heat loss between the resistive heating elements and the surface of the heater 504. It should be understood that the isothermal environment for the multizone heater 504 may employ other suitable configurations and should not be limited to the isothermal chamber 502.

The passive calibration setup 500 further includes a control system 506 that is similar to the control system 104 to control power to the heater 504. Here, the reference sensors are provided as multiple TCs 508 that are arranged to measure the surface temperature of the heater 504 at different locations along the surface such that at least one temperature measurement is acquired for each heating zone.

In this configuration, the control system 506 performs the R-T calibration process of the present disclosure to measure the resistance of the resistive heating elements and the surface temperature at each of the zones. An operator may set the frequency of the measurements to, for example, continuously measure resistance and temperature or to periodically obtain the measurements. Based on the data received, the control system 506 generates a R-T curve that associates the resistance of resistive heating elements with the surface temperature of the heater 504, which is indicative of the temperature of the resistive heating elements. In one form, the control system 506 provides an R-T curve for each heating zone using the resistance measurements for the resistive heating element at a given zone and the temperature measurements taken at the heating zone. For example, FIG. 3 illustrates R-T curves generated during a passive calibration for various two-zone heaters each having an inner zone and an outer zone.

For the active calibration process, the R-T calibration process is performed to acquire the R-T offset data with the heater 102 provided in the same operating conditions as when the heater 102 heats a workpiece. That is, the active calibration process captures the effect the operating conditions has on the heater 102 and thus, the resistive heating elements. Specifically, the R-T offset data may be different from the R-T offset data during the passive calibration process due to, for example, heat loss between the resistive heating element and the surface of the heater 102, and between the surface of the heater 102 and external environment.

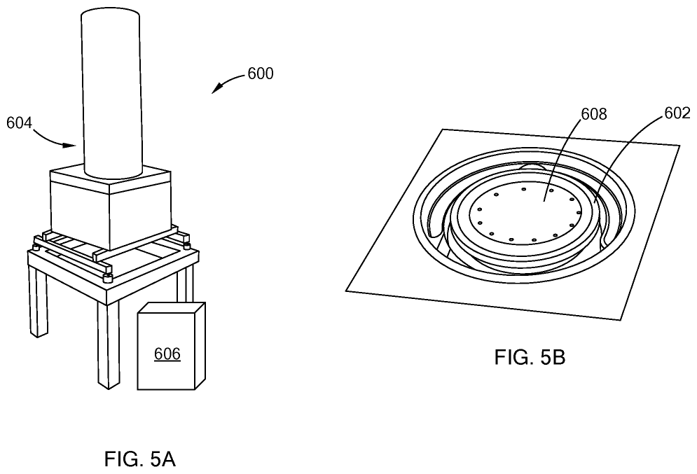

As an example, FIGS. 5A and 5B illustrate an active calibration test setup 600 in which a heater 602 is provided in a semiconductor processing chamber 604 that is designed to heat a semiconductor wafer. The heater 602 is a multizone heater similar to the heater 102. In this example, the semiconductor processing chamber 604 is for testing purposes and mimics actual semiconductor processing chambers. In one variation, the active calibration process may be performed at the actual semiconductor chamber manufacturing facility.

The active calibration test setup 600 further includes a control system 606 that is similar to the control system 104 to control power to the heater 602. Here, the reference sensor is provided as a TC wafer 608 that measures a surface temperature of the heater 602, which is the reference area being measured. In lieu of the TC wafer 608, one or more TCs or an IR camera may be used to measure the surface temperature of the heater 102. The control system 606 performs the R-T calibration process of the present disclosure to measure the resistance of the resistive heating elements and the surface temperature at each of the zones and generate the R-T offset data as described above.

While not illustrated in the calibration setups of FIGS. 4, 5A, and 5B, the respective control system is communicably coupled to the other components such as the reference sensors and/or heater.

In one form, a heater (such as, by way of example, the heater 102) may undergo the passive calibration and the active calibration to acquire R-T office data that associates controlled resistance measurements of the resistive heating elements from the passive calibration with the uncontrolled resistive measurements from the active calibration. In another form, the heater may undergo active calibration and not passive calibration.

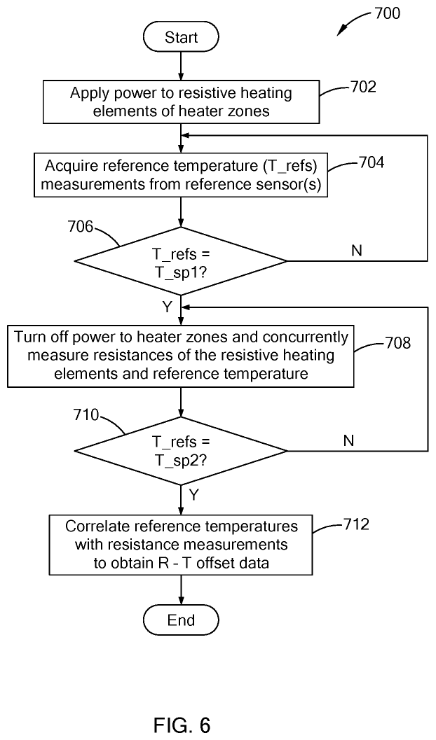

Referring to FIG. 6, a R-T calibration process 700 is provided, and may be executed by the control system of the present disclosure. With the reference sensor in place, the control system is configured to apply power to the heating zones to generate heat, at 702, and acquires reference temperature measurements from the reference sensor, at 704. At 706, the control system determines if the acquired reference temperature measurements are equal to a first temperature setpoint (T_sp1). That is, the control system receives temperature measurement for each heating zone of the heater and determines if the surface temperature of the heater is uniform (i.e., is at T_sp1). If so, the control system turns off power to the heater and concurrently measures resistances and reference temperature, at 708. At 710, the control system determines if the reference temperature is equal to a second temperature setpoint (T_sp2). If so, the control system stops measurements and correlates the reference temperatures with the resistance measurements to obtain R-T offset data, at 712.

It should be understood that the R-T calibration process 700 is just one example of the R-T calibration process and that other suitable routines may be used.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice; material, manufacturing, and assembly tolerances; and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, the term “controller” may be replaced with the term “circuit”. The controller may be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term code may include software, firmware, and/or microcode, and may refer to programs, routines, functions, classes, data structures, and/or objects. The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method of calibrating a heater, the method comprising:
powering a heater in an isothermal environment to a first temperature setpoint, wherein the heater comprises a resistive heating element having a temperature coefficient of resistance;
concurrently obtaining a plurality of resistance measurements of the resistive heating element and a plurality of reference temperature measurements of a reference member as the heater passively cools from a first temperature setpoint to a second temperature setpoint; and
generating a resistance-temperature calibration table that correlates the plurality of resistance measurements with the plurality of reference temperature measurements.

2. The method of claim 1 further comprising turning-off power to the heater when the heater is at the first temperature setpoint to passively cool the heater.

3. The method of claim 1, wherein the reference member is an exterior surface of the heater.

4. The method of claim 3, wherein the plurality of reference temperature measurements of the surface of the heater are obtained with an infrared camera.

5. The method of claim 1, wherein the plurality of reference temperature measurements are obtained with a thermocouple wafer and the reference member is the thermocouple wafer.

6. The method of claim 1, wherein to obtain a resistance measurement from among the plurality of resistance measurements, the method further comprises measuring at least one of an electric current and a voltage concurrently with the plurality of reference temperatures, and determining the resistance measurement based on the measured at least one electric current and the voltage.

7. A method of calibrating a heater, the method comprising:
powering the heater in a designated environment to a first temperature setpoint, wherein the heater comprises a resistive heating element having a varying temperature coefficient of resistance;
concurrently obtaining a plurality of resistance measurements of the resistive heating element and a plurality of reference temperature measurements of a reference member as the heater passively cools from a first temperature setpoint to a second temperature setpoint that is lower than the first temperature setpoint; and
generating a resistance-temperature calibration table that correlates the plurality of resistance measurements with the plurality of reference temperature measurements.

8. The method of claim 7, wherein the designated environment is an isothermal environment.

9. The method of claim 7, wherein the designated environment is an operating environment in which the heater is operable to heat a workpiece.

10. The method of claim 7 further comprising turning-off power to the heater when the heater is at the first temperature setpoint to passively cool the heater.

11. The method of claim 7, wherein the reference member is an exterior surface of the heater.

12. The method of claim 11, wherein the plurality of reference temperature measurements of the exterior surface of the heater are obtained with an infrared camera.

13. The method of claim 7, wherein the plurality of reference temperature measurements are obtained with a thermocouple wafer and the reference member is the thermocouple wafer.

14. The method of claim 7, wherein to obtain a resistance measurement from among the plurality of resistance measurements, the method further comprises measuring at least one of an electric current and a voltage concurrently with the plurality of reference temperatures, and determining the resistance measurement based on the measured at least one electric current and the voltage.

15. A control system for controlling a heater having a resistive heating element, the control system comprising:
a power converter configured to provide an output voltage that is adjustable to the heater;
a controller configured to determine the output voltage to be applied to the heater, the controller comprises:
a memory configured to store a plurality of control programs for controlling the heater, wherein the plurality of control programs includes a calibration process; and
a processor configured to execute the plurality of control programs, wherein with the heater is in a designated environment, the calibration process includes instructions to:
turn-on power to the heater to heat the heater to a first temperature setpoint;
concurrently obtain a plurality of resistance measurements of the resistive heating element and a plurality of reference temperature measurements of a reference member as the heater passively cools from the first temperature setpoint to a second temperature setpoint; and
generate a resistance-temperature calibration table that correlates the plurality of resistance measurements with the plurality of reference temperature measurements.

16. The control system of claim 15, wherein the calibration process further includes instructions to turn-off power to the heater when the heater is at the first temperature setpoint to passively cool the heater.

17. The control system of claim 15, wherein the reference member is an exterior surface of the heater.

18. The control system of claim 15, wherein the second temperature setpoint is lower than the first temperature setpoint.

19. The control system of claim 15, wherein the designated environment is an isothermal environment.

20. The control system of claim 15, wherein to obtain a resistance measurement from among the plurality of resistance measurements, the calibration process further includes instructions to measure at least one of an electric current and a voltage concurrently with the plurality of reference temperature measurements, and determine the resistance measurement based on the at least one electric current and the voltage.
